(19) United States
(12) Patent Application Publication
(10) Pub. No.: US 2018/0111589 A1
(43) Pub. Date: Apr. 26, 2018

(54) VEHICLE JACK

(71) Applicants: Erhardt Wickaum Burger, Pretoria (ZA); Petrus Gideon Johannes Du Toit, Lynnwood (ZA)

(72) Inventors: Erhardt Wickaum Burger, Pretoria (ZA); Petrus Gideon Johannes Du Toit, Lynnwood (ZA)

(21) Appl. No.: 15/725,657

(22) Filed: Oct. 5, 2017

(30) Foreign Application Priority Data
Oct. 26, 2016 (ZA) 2016/07371

(51) Int. Cl. B60S 9/06; B66F 3/12; B60S 9/22

(52) U.S. Cl. CPC B60S 9/06; B60S 9/22; B66F 3/12

(57) ABSTRACT

The invention relates to a vehicle jack 12 integrated into a chassis of a vehicle 10 and comprises two jack assemblies 12.1, 12.2 arranged in end-to-end fashion along each side of the vehicle. Each jack assembly includes an elongate drive screw 20 and a pair of legs 9, one of which is pivotally connected to a screw follower 22. In addition, the jack 12 Includes a drive mechanism 14 comprising a bevel gear arrangement which is drivingly connected to the respective drive screws 20. Upon actuation of the drive mechanism 14, the pairs of legs 9 are simultaneously, pivotally displaced relative to the chassis between a retracted position, in which the legs 9 are substantially aligned and disposed at least partially within or around the chassis, thereby not to adversely affect the ground clearance, and an extended position.

### FIELD OF INVENTION

This invention relates to vehicle lifting devices, in particular to a jack which is integrated into a vehicle chassis.

### BACKGROUND OF INVENTION

Most vehicles come standard with a mechanical or hydraulic free-standing jack which is usually stowed away in a storage compartment of the vehicle. However, many road users have never used a vehicle jack and don't necessarily know how to operate it or where to position it in order to safely lift a wheel of the vehicle off the ground. Furthermore, a free-standing jack may be accidentally misplaced or removed from a vehicle, the fact of which may only come to the owner's attention in an emergency situation. Safety is also a concern. Many users have been injured whilst using a free-standing jack due to poor installation or other unsafe operating conditions such as an uneven or unstable ground surface.

Integrated screw-type mechanical or hydraulic stabilising jacks have been provided on caravans, trailers, camper vans or motor homes to provide stability to the vehicle when parked or stationary. These units are usually heavy units that bolt unto an undercarriage of the vehicle or trailer and potentially hamper the vehicle's ground clearance.

The invention aims, at least to some extent to address the above drawbacks.

### SUMMARY OF INVENTION

In accordance with a first aspect of the invention, there is provided a vehicle jack which includes:
a pair of jack assemblies which are operatively integrated into a lower part of a vehicle chassis, the assemblies being arranged end-to-end along a portion of the chassis, each jack assembly including:
   an elongate drive screw and a pair of legs, one of which is pivotally connected to a screw follower which is, in turn, screw-threadingly connected to the drive screw, the pair of legs being displaceable relative to the vehicle chassis between a retracted position and an extended position; and
a drive mechanism which is operatively drivingly connected to each jack assembly and configured simultaneously to displace the legs of each jack assembly relative to the chassis between their retracted and extended positions upon actuation of the drive mechanism, wherein each leg defines a longitudinally extending opening in an operatively upper side thereof which is configured to accommodate the drive screw such that when the legs are in their retracted position, they are substantially aligned and disposed at least partially within or around the chassis, thereby not to adversely affect the ground clearance of the vehicle during normal use thereof.

The drive mechanism may be arranged between the respective jack assemblies. Each jack assembly may include a foot which is connected to at least one of the legs. At least one of the legs may be telescopically extendable/retractable. The foot may be pivotally connected to the telescopic leg.

The drive mechanism may comprise a bevel gear arrangement which is drivingly connected to each drive screw of the respective jack assemblies.

The drive mechanism may be manually actuatable using a jack spanner. Alternatively, the drive mechanism may be electrically driven by way of an electrical motor.

Each leg may comprise a tubular, channel-shaped member defining a longitudinal, operatively upper opening therein. The telescopically extendable leg may comprise a primary member and a secondary member which is slideably received within the primary member.

Furthermore, the secondary member may include a series of longitudinally spaced apart holes. The telescopically extendable leg may include a spring-loaded locking pin or latch which is configured to pass through registering holes in the respective members to lock them in position relative to one another and to allow discrete lengthwise extension of the telescopically extendable leg.

The jack may be removably secured to the vehicle chassis using mounting plates and conventional fasteners in a manner which permits disassembly and removal of the jack from the vehicle in the event that maintenance or servicing is required.

A roller may be connected to an operatively lower part of the foot in order to facilitate sliding motion of the foot relative to the ground surface during deployment of the legs.

The invention extends to a vehicle which includes a vehicle jack as described above which is integrated into a hollow chassis or undercarriage of the vehicle.

An operatively lower portion of the chassis may define a longitudinal opening for receiving the vehicle jack. More specifically, the vehicle may include a pair of longitudinally extending and longitudinally spaced apart openings in the chassis for receiving the vehicle jack.

### BRIEF DESCRIPTION OF DRAWINGS

The invention will now be further described, by way of example, with reference to the accompanying diagrammatic drawings.

In the drawings:

FIG. 1 shows a vehicle in accordance with one aspect of the invention;

FIG. 2A shows a three-dimensional view of a vehicle jack in accordance with another aspect of the invention, in a retracted position:

FIG. 2B shows an exploded view of part of a mounting mechanism of the vehicle jack of FIG. 2A;

FIGS. 3A and 3B show top and side views respectively of a drive mechanism which forms part of the vehicle jack of FIG. 2A;

FIG. 4 shows a side view of the jack of FIG. 2A;

FIG. 5 shows a three-dimensional view of the jack in a partially extended position;

FIG. 6 illustrates a side view of the jack of FIG. 5;

FIG. 7 illustrates a three-dimensional view of the jack in a telescopically extended position;

FIG. 8 is an enlarged cross-sectional view of detail A shown in FIG. 6;

FIG. 9 is a side view of the jack of FIG. 7;

FIG. 10 is a cross-sectional view taken along line X-X in FIG. 9;

FIG. 11A is a side view of an alternative embodiment of the vehicle jack; and

FIGS. 11B and 11C show enlarged end and side views, respectively, of a roller mounted to a foot of the jack of FIG. 11A

### DETAILED DESCRIPTION OF AN EXAMPLE EMBODIMENT

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

In the figures, reference numeral 10 refers generally to a vehicle in accordance with one aspect of the invention which includes an integrated jack 12 in accordance with a further aspect of the invention. The jack 12 comprises at least two jack assemblies 12.1, 12.2 which are arranged end-to-end within a lower portion of a vehicle chassis. The jack assemblies 12.1, 12.2 are integrated into a longitudinally extending, hollow, tubular, side frame member 13 of the chassis. The jack 12 is installed in a manner that permits it to be disassembled or dismantled in the event that maintenance needs to be conducted or a worn or damaged part needs to be replaced. In order to allow lifting of either side of the vehicle, it will be appreciated that the vehicle 10 will preferably include two jacks 12, one on either side of the vehicle 10.

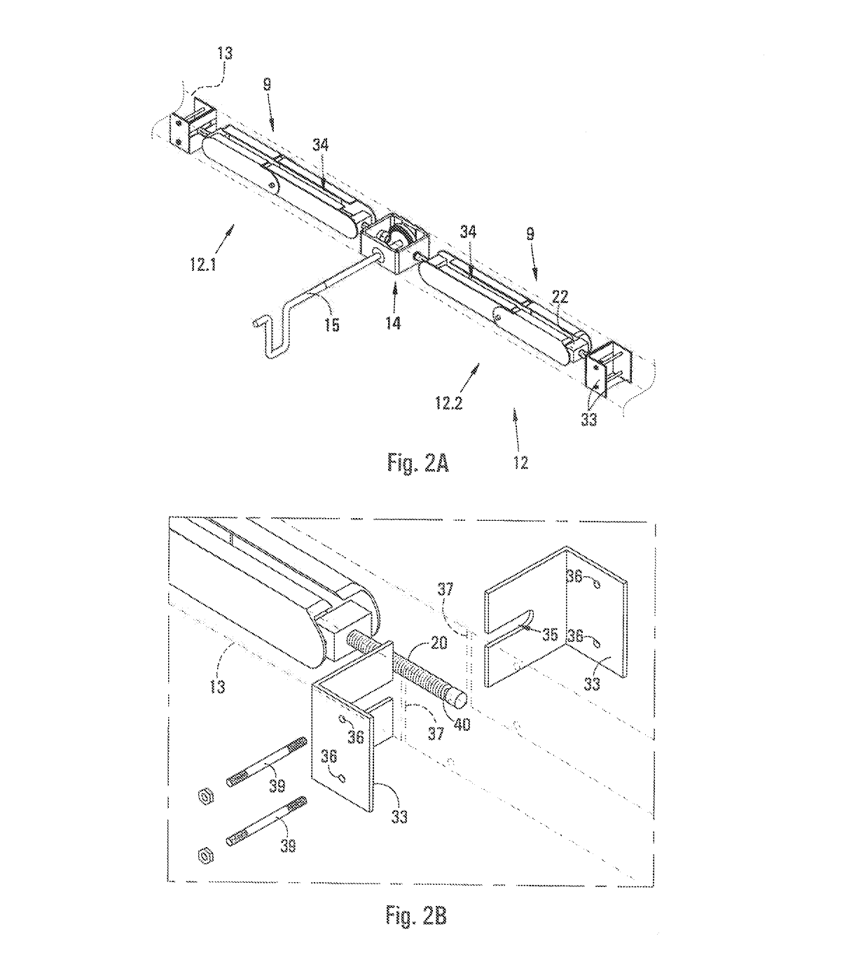

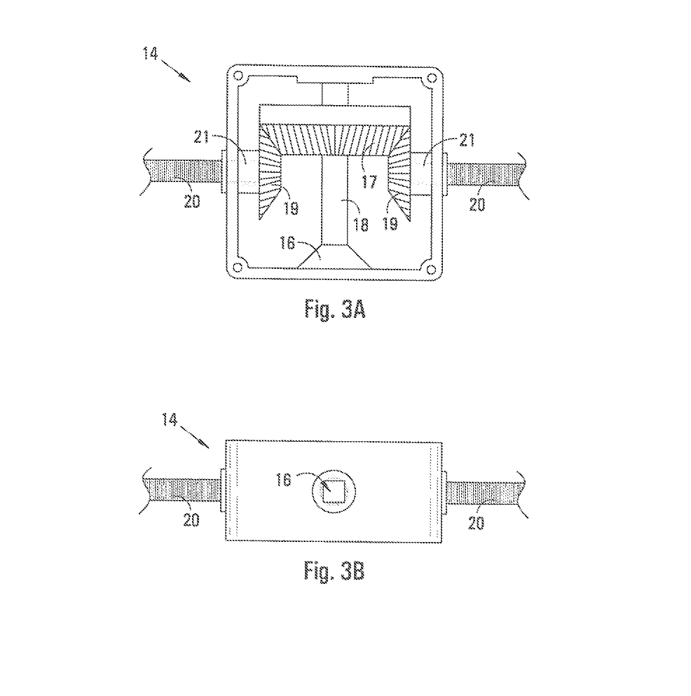

Referring now to FIGS. 2A, 2B, 3A and 3B, each jack 12 includes a drive mechanism 14 which is drivingly connected to the respective jack assemblies 12.1, 12.2. In this example embodiment the drive mechanism 14 is actuated manually through use of an angled crank spanner or jack spanner 15 which engages a drive socket 16 (see FIG. 3B) forming part of the drive mechanism 14. However, it will be appreciated that the drive mechanism 14 may also be actuated electrically by way of an electrical motor (not shown) which may be integrated into the control system of the vehicle. In the figures, the manually actuated configuration has been illustrated. Accordingly, the drive mechanism 14 includes a gear box which houses a primary drive gear 17 in the form of a bevel gear to which is connected a drive shaft 18 defining a drive axis. The drive socket 16 is configured to receive a complemental end of the jack spanner 15 and is connected to an end of the drive shaft 18. The drive socket 16 presents outwardly to allow an operator easy access thereto. The drive mechanism 14 further includes a pair of bevel screw gears 19 which mesh with the drive gear 17. Each screw gear 19 has a shaft which passes through a side of the gear box at a right angle to the drive axis and is coupled to a drive screw 20 of the respective jack assemblies 12.1, 12.2. The drive screws 20 collectively define a screw axis. Also, the drive screws 20 are substantially aligned with one another along the screw axis. A square end 21 of each drive screw 20 is configured to mate with a complemental recess formed in the shaft of each bevel gear 19 in order to transfer drive from the bevel gear shaft to the drive screw 20. The drive mechanism 14 is disposed between the respective jack assemblies 12.1, 12.2, more or less in the middle of the side frame member 13.

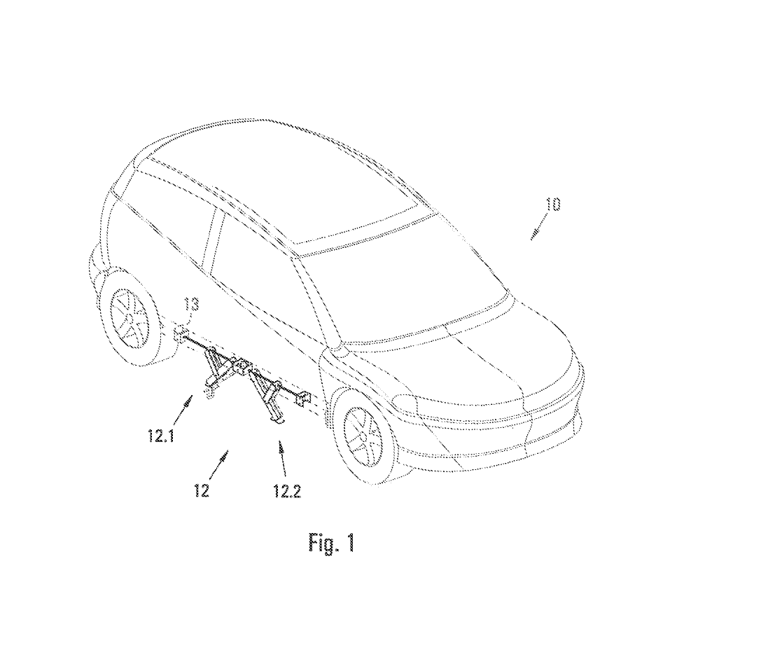

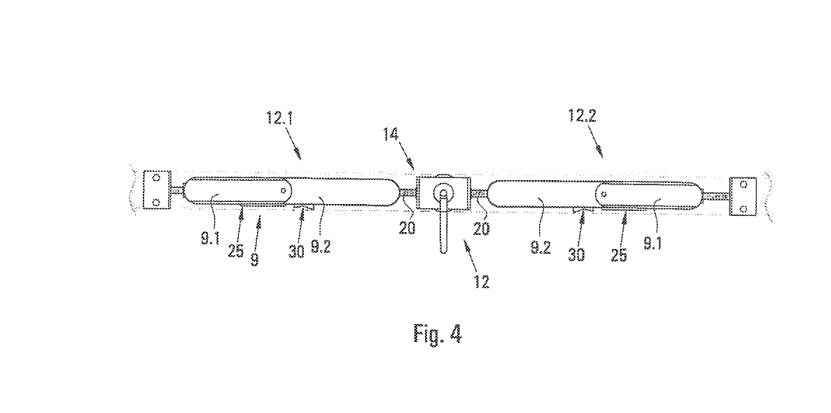

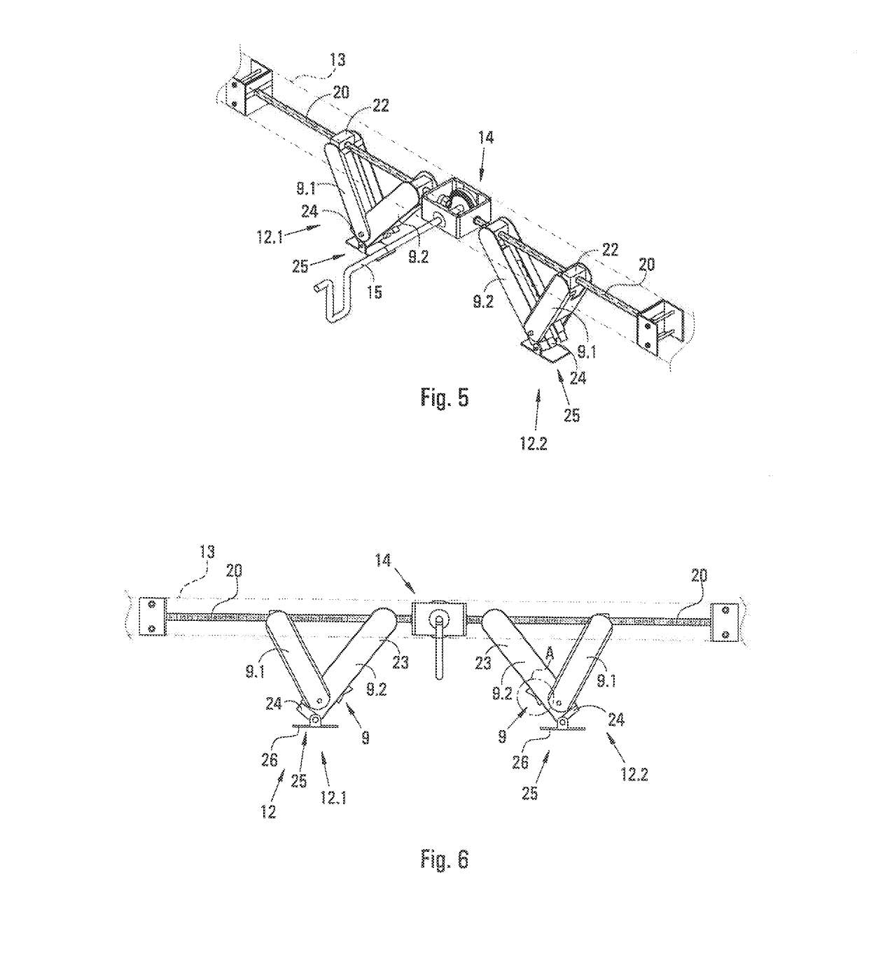

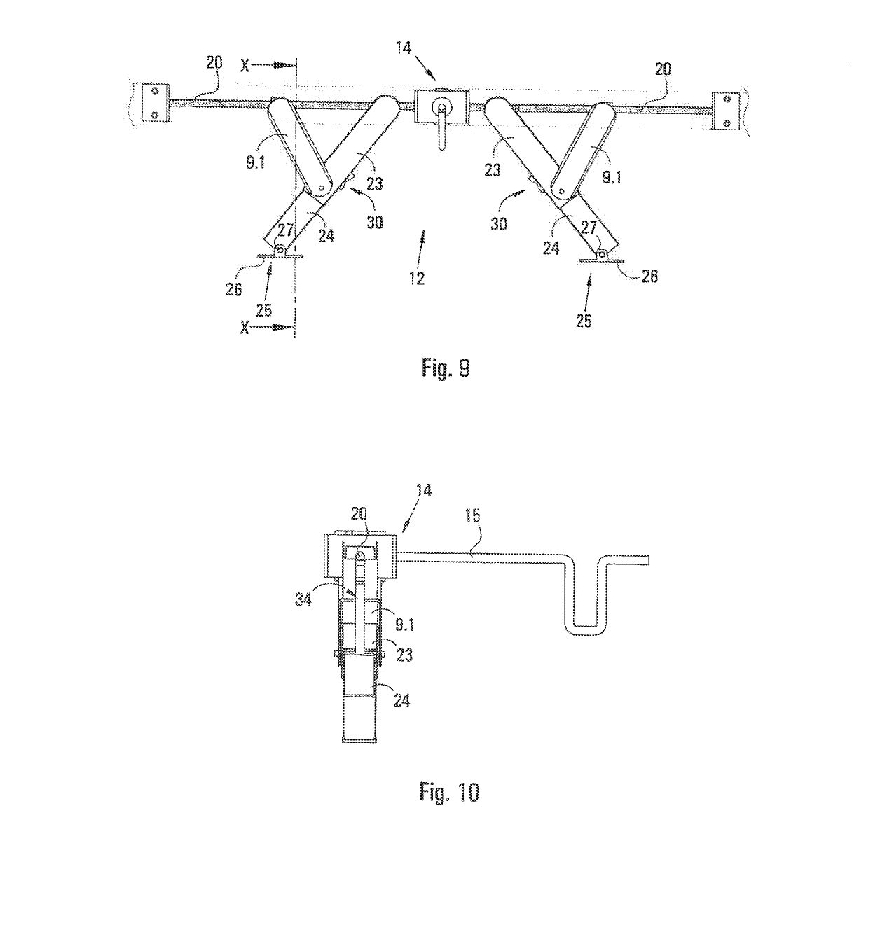

Each jack assembly 12.1, 12.2 further includes a pair of legs 9. The pair comprises a first, axially outer leg 9.1 and a second axially inner leg 9.2, which are pivotally interconnected. One end of the axially outer leg 9.1 of the pair is pivotally connected to a screw follower 22 (see FIG. 5) which is screw-threadingly mounted to the drive screw 20 and is axially displaceable along the screw axis when the screw 20 is rotated. An end of the second, axially inner leg is journalled on an axially inner part of the drive screw 20 proximate the drive mechanism 14 and remains stationary when the screw 20 is rotated. The legs 9 are displaceable between a retracted position (FIGS. 2 and 4) in which the legs 9 are at least partially received within the frame member 13 and accordingly abut an underside of the chassis, and an extended or deployed position (FIGS. 1, 7 and 9) in which the legs 9 extend downwardly away from the chassis in order to support the weight of the vehicle 10. In order to compensate for vehicles having different ground clearances, the second leg 9.2 of the pair is telescopically extendable/retractable. To this end, the leg 9.2 comprises a hollow channel-shaped primary member 23 and a similarly channel-shaped secondary member 24 which is slideably received within the primary member 23. Accordingly, the primary member 23 defines a marginally greater cross-sectional area in order to accommodate the secondary member 24 therein. Furthermore, a foot 25 which has a substantially planar base 26 is pivotally connected to a distal end of the secondary member 24 of the second leg 9.2 by way of a laterally extending mounting pin which protrudes through registering holes in the end of the secondary member 24 and in corresponding mounting plates 27 (see FIG. 9) which extend upwards on either side of the base 26 of the foot 25.

Referring now to FIG. 8, a series of longitudinally spaced apart discrete holes 28 in an operatively underside of the secondary member 24 provide for telescopic extension/retraction of the second leg 9.2 to discrete lengths by way of a spring-loaded, locking pin or latch 30 articulated to the primary member 23 of the second leg 9.2. The locking pin 30 is biased to a locked position by a spring and, accordingly, a bevelled tip 31 of the pin 30 protrudes through a pin hole in the primary member 23 and has a bevelled face which facilitates quick release or extension of the secondary member 24 relative to the primary member 23. In order to retract the secondary member 24, a raised end 32 of the latch 30 is depressed which retrieves the tip 31 from the hole and allows the secondary member 24 to be slid inwardly with respect to the primary member 23.

Referring back to FIGS. 2A and B, an axially outer end of each drive screw 20 is journaled, i.e. has a peripheral groove 40 which accommodates a pair of angled mounting plates 33. Each mounting plate 33 defines a thumb-shaped cut-away 35 on an inner face which engages with the groove in the drive screw 20 in order to retain the screw 20 in place whilst permitting it to rotate, and a pair of mounting holes 36 on an outer face. In order to render the drive screw 20 removable, the inner face of each mounting plate 33 is slid into a slot 37 formed in a side of the frame member 13 such that the holes 36 are in register with holes in the frame member 13 for receiving fasteners in the form of bolts and nuts 39 which pass through opposing outer faces of the plates 33 to secure them in place. The drive mechanism 14 including the gear box is also removably secured to an inside of the frame member 13. To this end, the respective drive shafts are removably coupled to the drive screws 20 in conventional fashion.

As can be seen in FIGS. 2A and 10, the legs 9 comprise tubular channel-shaped members which define a longitudinal slot or groove 34 in an operatively upper side which is sized to accommodate the drive screw 20. As can be seen in FIGS. 2A and 4, when the jack 12 is in its retracted position, the legs 9 cover or close over a substantial portion of the length of the respective drive screws 20. In so doing, the legs 9, including the foot 25, prevent the accumulation of dirt and grime on the lubricated drive screw 20, thereby prolonging its life. Although this has not been clearly illustrated in the drawings, it will be appreciated that the longitudinally extending side frame member 13 has a longitudinally extending slot or opening through which the legs 9 protrude when in their respective positions. In their retracted position (FIGS. 2 and 4), the legs 9 and feet 25 substantially close the slot or opening in the side frame member 13.

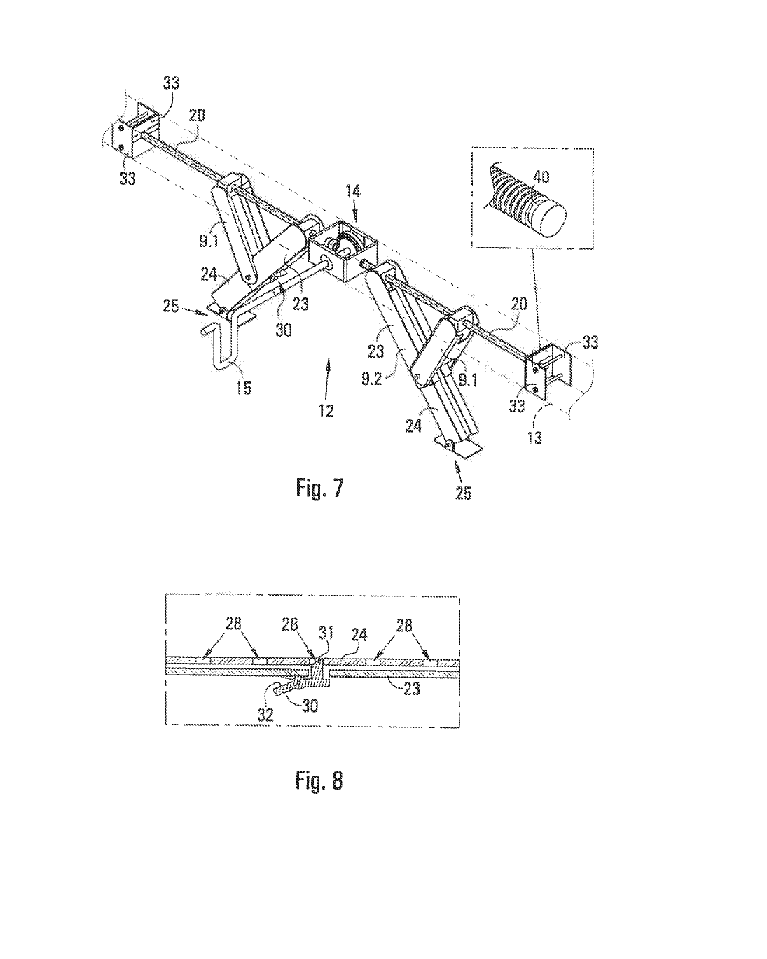

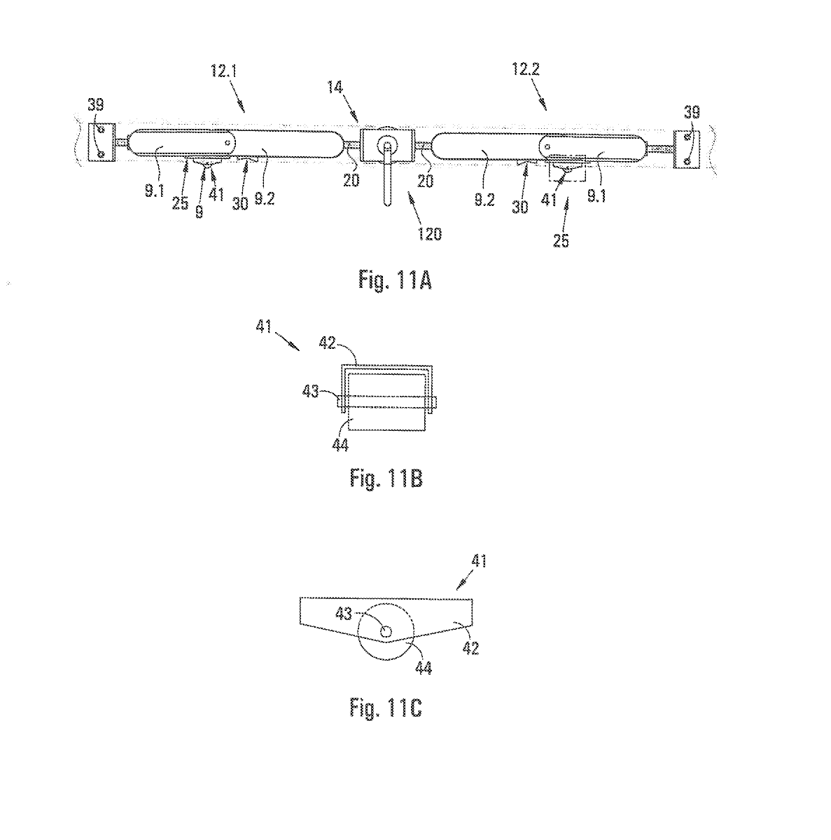

During normal use of the vehicle 10, the jack assemblies 12.1, 12.2 are in their retracted position and do not adversely affect the ground clearance of the vehicle because they are accommodated within the chassis of the vehicle. In the event of a puncture, the driver retrieves the jack spanner 15 from a storage compartment of the vehicle and engages a square tip of the spanner 15 with the drive socket 16 and manipulates the spanner 15 in order to rotate the respective gears 17, 19 and drive screws 20 which initiates simultaneous, axially inward displacement of the respective screw followers 22 to which the axially outer first legs 9.1 are attached. The legs 9 of each jack assembly accordingly pivot relative to one another in a vertically downwardly extending plane until the foot 25 engages a ground surface. Continued actuation of the jack spanner 15 will serve to lift the one side of the vehicle 10 from the ground. In other words, in the case of a four wheeled vehicle the front and rear wheels on one side of the vehicle will be lifted off the ground simultaneously. If the vehicle happens to have a particularly high ground clearance and upon extension of the legs 9 as shown in FIGS. 5 and 6, the feet 25 are still not engaging the ground surface in order to lift the wheels off the ground, the secondary member 24 of the second leg 9.2 may be telescopically extended by slideably displacing the secondary member 24 relative to the primary member 23 to the position illustrated in FIGS. 7 and 9. In this way, the reach of the jack 12 can be extended. Before stowing away the jack 12 by retracting the legs 9 through reverse operation of the jack spanner 15, an operator depresses the protruding end 32 of the spring-loaded locking pin 30 in order to retract the tip 31 of the locking pin 30 from the hole in the secondary member 24 in order to allow relative longitudinal displacement of the members. Continued reverse operation of the jack spanner 15 will ensure that the legs 9 track back into their retracted position illustrated in FIGS. 2 and 4. As shown in FIGS. 11A, B and C, in an alternative embodiment of the vehicle jack 120, a roller 41 is provided on the base 26. Each roller 41 has a U-shaped mounting bracket 42 and a pin 43 which retains the roller 44 in place. The rollers 41 facilitate smooth engagement of the feet of the jack with the ground and prevents it from jamming or getting stuck.

The Applicants believe that the vehicle jack 12, 120 in accordance with the invention improves upon existing vehicle jack operation and use, firstly, because it is integrated into the vehicle 10 and therefore cannot be accidentally misplaced or removed from the vehicle. Secondly, operation is simplified which means anybody can easily lower the jack 12 using of the jack spanner 15. Many road users may not know how to use a conventional free-standing jack or may be unsure where on the vehicle it is safe to position the jack prior to lifting. The integrated vehicle jack 12 overcomes the above drawbacks. Furthermore, a poorly installed conventional jack can fall over which poses a safety risk and could potentially damage the vehicle or injure the operator. However, when using the jack 12 in accordance with the invention, a pair of legs on each side of the vehicle 10 provide additional stability and safety during lifting which means the jack cannot fall over and injure the operator or damage the vehicle. The vehicle is also more stable than when using a single jack and both wheels can be changed at the same time. Also, the telescopically extendable leg of each jack assembly 12.1, 12.2, allows it to be used on vehicles with differing ground clearances and wheelbases.

1. A vehicle jack which includes:
a pair of jack assemblies which are operatively integrated into a lower part of a vehicle chassis, the assemblies being arranged end-to-end along a portion of the chassis, each jack assembly including:
an elongate drive screw and a pair of legs, one of which is pivotally connected to a screw follower which is, in turn, screw-threadingly connected to the drive screw, the pair of legs being displaceable relative to the vehicle chassis between a retracted position and an extended position; and
a drive mechanism which is operatively drivingly connected to each jack assembly and configured simultaneously to displace the legs of each jack assembly relative to the chassis between their retracted and extended positions upon actuation of the drive mechanism, wherein each leg defines a longitudinally extending opening in an operatively upper side thereof which is configured to accommodate the drive screw such that when the legs are in their retracted position, they are substantially aligned and disposed at least partially within or around the chassis, thereby not to adversely affect the ground clearance of the vehicle during normal use thereof.

2. A vehicle jack as claimed in claim 1, wherein the drive mechanism is arranged between the respective jack assemblies.

3. A vehicle jack as claimed in claim 2, wherein each jack assembly includes a foot which is connected to at least one of the legs.

4. A vehicle jack as claimed in claim 3, wherein at least one of the legs is telescopically extendable/retractable.

5. A vehicle jack as claimed in claim 4, wherein the foot is pivotally connected to the leg.

6. A vehicle jack as claimed in claim 2, wherein the drive mechanism comprises a bevel gear arrangement which is drivingly connected to each drive screw of the respective jack assemblies.

7. A vehicle jack as claimed in claim 6, wherein the drive mechanism is manually actuatable using a jack spanner.

8. A vehicle jack as claimed in claim 6, wherein the drive mechanism is electrically driven by way of an electrical motor.

9. A vehicle jack as claimed in claim 4, wherein each leg comprises a tubular channel-shaped member defining a longitudinal, operatively upper opening therein.

10. A vehicle jack as claimed in claim 9, wherein the telescopically extendable leg comprises a primary member and a secondary member which is slideably received within the primary member.

11. A vehicle jack as claimed in claim 10, wherein the secondary member includes a series of longitudinally spaced apart holes, and wherein the telescopically extendable leg includes a spring-loaded locking pin which is configured to pass through registering holes in the respective members to lock them in position relative to one another and to allow discrete lengthwise extension of the telescopically extendable leg.

12. A vehicle jack as claimed in claim 1, which is removably secured to the vehicle chassis using mounting plates and conventional fasteners in a manner which permits disassembly and removal of the vehicle jack from the vehicle in the event that maintenance or servicing is required.

13. A vehicle jack as claimed in claim 5, wherein a roller is connected to an operatively lower part of the foot in order to facilitate sliding motion of the foot relative to the ground surface during deployment of the legs.

14. A vehicle which includes a vehicle jack as claimed in claim 1 which is integrated into a hollow chassis or undercarriage of the vehicle.

15. A vehicle as claimed in claim 14, wherein an operatively lower portion of the chassis defines a longitudinal opening for receiving the vehicle jack.

16. A vehicle as claimed in claim 15, which includes a pair of longitudinally extending and longitudinally spaced apart openings in the chassis for receiving the vehicle jack.
